(19) United States
(12) Patent Application Publication
(10) Pub. No.: US 2008/0297829 A1
(43) Pub. Date: Dec. 4, 2008

(54) SYSTEM AND METHOD FOR PROVIDING PERSONALIZED SETTINGS ON A MULTI-FUNCTION PERIPHERAL (MFP)

(75) Inventor: Jeanette Paek, Cypress, CA (US)

Correspondence Address: KNOBBE MARTENS OLSON & BEAR LLP, 2040 MAIN STREET, FOURTEENTH FLOOR, IRVINE, CA, 92614, US

(73) Assignee: Samsung Electronics Co., Ltd., Suwon city (KR)

(21) Appl. No.: 11/757,907

(22) Filed: Jun. 4, 2007

(51) Int. Cl. G06F 3/12

(52) U.S. Cl. 358/1.15

(57) ABSTRACT

A system and method for providing personalized settings on a multi-function peripheral (MFP) are described. The system comprises a MFP with a user interface such as a front panel. The system further comprises a preference unit configured to store a group of settings for each of a plurality of user accounts. The MFP is configured to a) log on a user to a user account, b) retrieve a group of settings associated with the user account from the preference unit, and c) customize the user interface of the MFP with the retrieved settings.

### BACKGROUND OF THE INVENTION

1. Field of the Invention

The invention relates to multi-function peripherals (MFPs). More particularly, the invention relates to personalized settings on a MFP.

2. Description of the Related Technology

A MFP may be shared by multiple users. The front panel of conventional MFP devices presents users with the same generic menus to navigate in order to perform a function. Although some existing MFP devices required user authentication, the authentication is typically used for access control (whether a user can use the device or not) or accounting and controlling resources, not for personalized settings. As a result, a user is often required to go through many steps to change the settings to fit their personal needs, such as specific scan/fax settings. These steps can lead to some confusion and inefficiency. For example, to scan a document to email or fax, a user needs to type in email addresses and fax phone numbers. When there are many recipients, it is very cumbersome to type all the destination addresses/phone numbers. In order to increase work efficiency, there is a need to provide personalized settings for each user on the MFP.

### SUMMARY OF CERTAIN INVENTIVE ASPECTS

The system, method, and devices of the invention each have several aspects, no single one of which is solely responsible for its desirable attributes. Without limiting the scope of this invention, its more prominent features will now be briefly discussed.

In one aspect, there is a system of providing personalized settings on a user interface of a multi-function peripheral (MFP). The system comprises a MFP with a user interface. The system further comprises a preference unit configured to store a group of settings for each of a plurality of user accounts. The MFP is configured to a) log on a user to a user account, b) retrieve a group of settings associated with the user account from the preference unit, and c) customize the user interface of the MFP with the retrieved settings.

In another aspect, there is a method of providing personalized settings on a user interface of a multi-function peripheral (MFP). The method comprises logging on a user to a user account. The method further comprises retrieving a group of settings associated with the user account from a preference unit. The method further comprises customizing the user interface of the MFP with the retrieved settings.

In another aspect, there is a system for providing personalized settings on a user interface of a multi-function peripheral (MFP). The system comprises means for logging on a user to a user account. The system further comprises means for retrieving a group of settings associated with the user account from a preference unit. The system further comprises means for customizing the user interface of the MFP with the retrieved settings.

### BRIEF DESCRIPTION OF THE DRAWINGS

FIG. 1 is a block diagram illustrating one embodiment of a system for providing personalized settings at the front panel of a MFP.

FIG. 2 is a flowchart of one embodiment of a method of providing personalized settings at the front panel of a MFP.

FIG. 3 is a flowchart of one embodiment of a method of modifying the personalized settings at the front panel of a MFP.

FIG. 4 is a diagram illustrating an exemplary view of a customized front panel of a MFP device.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements. In the following description, specific details are given to provide a thorough understanding of the disclosed methods and apparatus. However, it will be understood by one of ordinary skill in the technology that the disclosed systems and methods may be practiced without these specific details. For example, electrical components may be shown in block diagrams in order not to obscure certain aspects in unnecessary detail. In other instances, such components, other structures and techniques may be shown in detail to further explain certain aspects.

It is also noted that certain aspects may be described as a process, which is depicted as a flowchart, a flow diagram, a structure diagram, or a block diagram. Although a flowchart may describe the operations as a sequential process, many of the operations may be performed in parallel or concurrently and the process may be repeated. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The purpose of certain embodiments as will be described below is to provide each of a plurality of users a group of personalized settings on a user interface of a MFP device. Though a control panel (also referred to as a front panel) is used as an example of the user interface in these embodiments, other types of user interfaces may be used as well. The group of personalized settings for a user may include, for example, his own address book or contact list, calendar, personal virtual document storage such as network drives, access to document server, preferred RSS (e.g. really simple syndication) feed, and preferred scan/copy/fax settings. The group of settings may also be customized by the administrator such that only features that are accessible to a user are displayed.

In one embodiment, the personalized settings are stored on a preference server. A user may set his own personalized settings in a web browser connected to the preference server. When the user logs in at the front panel, the MFP retrieves the personalized settings stored on the preference server and customizes the display of the front panel accordingly.

These embodiments provide users with the ability to personalize their MFP devices. Also, a user may personalize the settings only once and then have such personalized settings displayed on as many devices that support this feature. It does not matter whether the user is accessing a MFP device at a local office or an overseas office, or other remote location. Further, such personalized settings may include access control such that a user is only presented with features or functions that they are allowed to access. This avoids confusion to a user and makes the menu choices more concise.

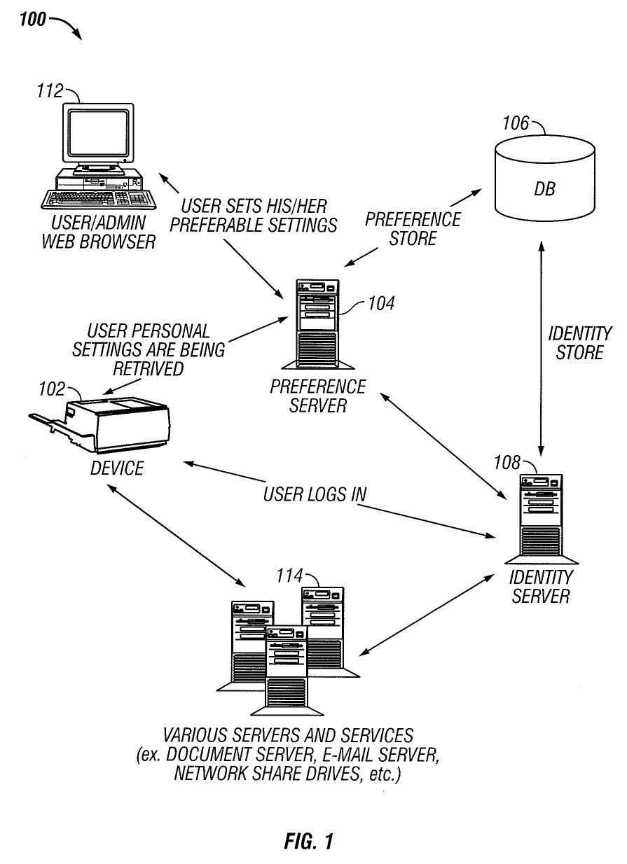

FIG. 1 is a block diagram illustrating one embodiment of a system for providing personalized settings at the front panel of a MFP. Examples of the personalized setting may include, but not limited to, address book or contact list, calendar, personal virtual document storage such as network drives, access to document server, preferred RSS (e.g. really simple syndication) feed, preferred scan/copy/fax settings, user logs, notepad, and various user configurable items. The group of settings may also be customized by the administrator such that only features that are accessible to a user are displayed. In one embodiment, the MFP provides support of a dynamic user interface so that the users may define their own preferred user interface.

The system 100 includes a MFP 102. A MFP refers to a type of equipment connectable to a personal computer (PC) or network that handles two or more of the following functions: printing, emailing, copying or faxing. It is also called a multi-function product, a multi-function printer, a multi-function device, an All-in-One device, etc. Though a MFP is used as an example for illustration, the embodiments are applicable to other devices having a front panel such as a printer, facsimile, scanner, or copy machine.

The MFP 102 includes a front panel which provides a user interface to control and operate the devices. Typically, a front panel has a menu interface. The user may look at a menu, select one of the controls (such as a menu tab, a menu item, an icon or a button) on display, and go to the next screen associated with the selected control. A control may be selected when, for example, a user clicks on the control. The menu interface of the front panel may be customized with personalized settings by the MFP 102. In one embodiment, the front panel may be locally attached to the MFP 102. In another embodiment, the front panel may be a remote user interface that gives a user the ability to remotely control the device.

The system 100 includes a preference unit 104 configured to store personalized settings associated with each user account and allow users to set/modify his personalized settings. When a user logs into a user account at the MFP 102, the MFP 102 retrieves personalized settings associated with the user account from the preference unit and customizes the front panel with the retrieved personalized settings.

In one embodiment, the preference unit 104 comprises a preference server. The preference server may be integrated within or in communication with the MFP 102. The preference server may be accessed by a user via a communication link such as a network connection to set the group of personalized settings. In one embodiment, the preference server may include a web server.

The system 100 may further comprise a remote user interface 112 connected to the preference server 104. A user may set or modify his personalized settings via the remote user interface. The remote user interface may be any type of equipment suitable for this function, including but not limited to, a personal computer, a personal digital assistant, a network terminal, and a mobile phone. In one embodiment, a user may set or modify their personalized settings in a web browser opened at the remote user interface 1 12.

The system 100 may further comprise an identity server 108 configured to manage a plurality of user accounts and provide authentication for each user to log in. When a user views the front panel of the MFP 102, the user is prompted to enter his account information (e.g., authentication data). The MFP 102 then works with the identity server 108 to log the user into his user account. The identity server 108 attempts to verify the account information relayed by the MFP 102. If a user account is found to be associated with the account information entered by the user, the identity server 108 retrieves the associated user account and returns such information to the MFP 102. In one embodiment, the authentication data is an identification code or number, for example, a username which conforms to a variation of a person's name. Additional information about the user such as a password or a PIN number may also be included.

In one embodiment, the system 100 may comprise a data repository 106 which stores information such as the personalized settings previously stored on the preference server 104 and the authentication data previously stored on the identity server 108. The preference server 106 and the identity server 108 would send or retrieve data stored on the repository 106 depending on the operation to be performed. The repository 106 may be any device suitable for data storage, including, but not limited to, a hard disk, a network drive, and flash storing media. The data may be stored in any suitable format on the repository 106.

It will be appreciated that one or more of the MFP 102, the preference server 104, the identity server 108, and the repository 106 may be merged together or removed, depending on the particular application. For example, in a small workgroup environment where there are a small number of users and limited server resources, the preference service and identity service can be run on the MFP device 102 to eliminate the need of host service components.

The system 100 may further include other servers 114 configured to perform a particular function. The user may set personalized settings for the function provided by the server 114 and access such function via the MFP 102. Depending on the application, the server 114 may be, for example, a document server, an email server, or a network share drive.

In one embodiment, the same account information that a user uses to access the MFP 102 is used to access the one or more servers 114. A user, after being logged into the MFP 102, may be able to access the servers 114 via the MFP 102 without another login. The MFP 102 relays the user account information to the one or more servers 114. This may be implemented by, for example, a basic Single Sign-On (SSO) functionality. SSO refers to a method that allows a user to log into an application once, and removes the necessity to authenticate again when the same user accesses any other application that is federated (linked) and with which the user already has an account.

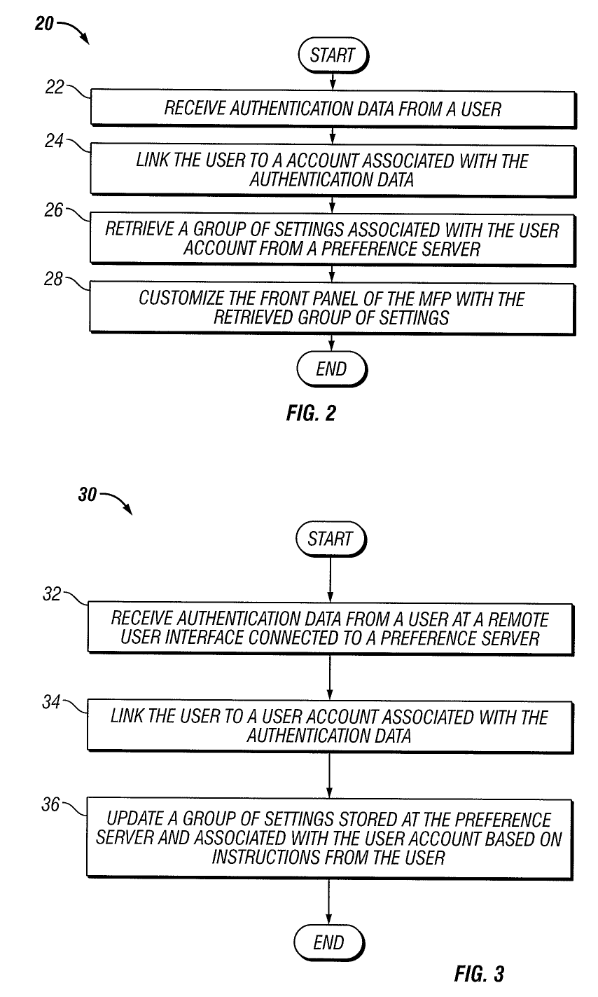

FIG. 2 is a flowchart of one embodiment of a method of providing personalized settings via the front panel of a MFP. The exemplary method 20 may be performed on, for example, a system as described in FIG. 1. Depending on the embodiment, the process to be carried out in certain blocks of the method may be removed, merged together, or rearranged in order. The general principle of the exemplary method will be described as below.

Before the method starts, a set of personalized settings have been stored on the preference server according to a method which will be described later with regard to FIG. 3.

The method 20 begins at a block 22, wherein the MFP 102 receives authentication data from a user. In this process, a user enters their account information (e.g., authentication data) via the front panel of the MFP. The authentication data is used to verify the user's identity and link it to a user account. The authentication data may be, for example, a username and a password.

Next at a block 24, the MFP 102 links the user to a user account associated with the authentication data. The MFP 102 first sends the authentication information entered by the user to the identity server 108. The identity server 108 then checks whether the authentication information is associated with a valid user account. If a valid user account is identified, the identity server 108 then returns the account information to the MFP 102.

Moving to a block 26, the MFP 102 retrieves a group of personalized settings associated with the user account from the preference server 104. The MFP 102 sends the user account information to the preference server 104, which then retrieves a group of personalized settings associated with the user account and sends to the MFP 102.

Lastly, at a block 28, the MFP 102 customizes its front panel display with the retrieved group of settings. The user may see, for example, a contact list customized particularly for his or her use.

In one embodiment, the identity server may be integrated within the preference server. In that case, blocks 24 and 26 may be revised slightly. At a block 24, the MFP 102 sends the authentication information entered by the user to the preference server 104. The preference server 104 then checks whether the authentication information is associated with a valid user account. When a valid user account is identified, the preference server 104 then returns a group of personalized settings associated with the user account to the MFP 102. The user account is not necessarily returned to the MFP 102. This embodiment may be useful for certain applications.

FIG. 3 is a flowchart of one embodiment of a method of modifying the personalized settings via the front panel of a MFP. The method may be performed to allow, for example, a user to update personalized settings associated with his user account or an administrator to update personalized settings associated with multiple user accounts to implement access control. The exemplary method 30 may be performed on, for example, a system as described in FIG. 1. Depending on the embodiment, the process to be carried out in certain blocks of the method may be removed, merged together, or rearranged in order. The general principle of the exemplary method will be described as below.

The method 30 begins at a block 32, where a remote user interface 112 receives authentication data from a user. In this process, a user accesses a remote user interface to connect to the preference server 104, in order to set or modify the group of personalized settings associated with a user account. The user first enters the authentication data at prompt by the remote user interface 112.

Next at a block 34, the preference server 104 links the user to a user account associated with the authentication data. In this process, the preference server 104 first sends the authentication information entered by the user to the identity server 108. The identity server 108 then checks whether the authentication information is associated with a valid user account. If a valid user account is found, the identity server 108 then returns the account information to the preference server 104. The preference server 104 then logs the user in to his user account.

Lastly, at a block 36, the preference server 104 updates a group of personalized settings stored at the preference server and associated with the user account based on instructions from the user. In this process, the user updates the groups of personalized settings associated with a respective user account via the remote user interface 112. Changes made by the user at the remote user interface 112 are transferred to the preference server 104 and then stored therein.

The foregoing embodiments enable a device such as a MFP to customize its front panel with a group of personalized settings for each of a plurality of users. A user may easily set or change a group of personalized settings associated with his account at any remote user interface connected to the preference server. The same preference server may be shared by multiple devices. Once a user changes his personalized settings stored on the preference server, he can access the personalized settings at the front panel of any one of the multiple devices. Also, the group of settings may include access control such that only features that are accessible to a user may be displayed.

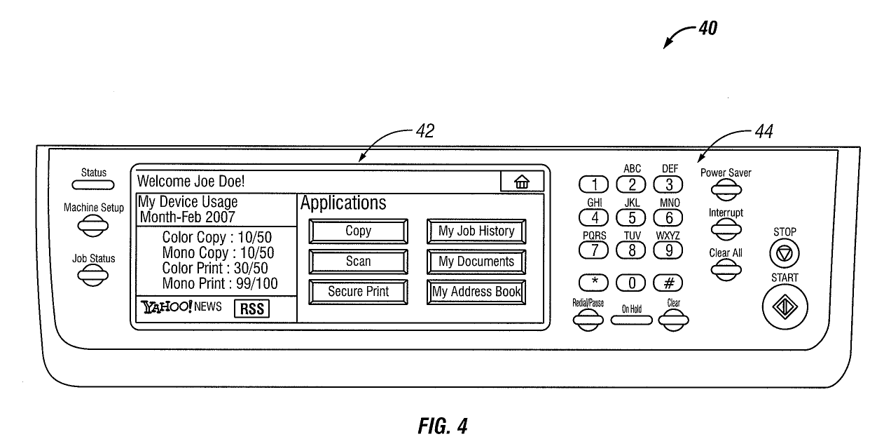

FIG. 4 illustrates an exemplary view of a customized front panel of a MFP device. The front panel 40 provides a user interface to control and operate the device. The front panel 40 includes a display 42 and a set of buttons 44. The display 42 shows a menu. A user may look at the menu as displayed, select one of the controls (such as a menu tab, a menu item, an icon or a button) on display, and go to the next screen associated with the selected control. A control may be selected when, for example, a user clicks on the control. A user may also operate the device by pressing one of the buttons 44.

In FIG. 4, the front panel of the MFP device is customized with personalized settings associated with a user named Joe Doe. The front panel shows Joe Doe's device usage count for the month, and a personalized list of applications which varies from one user to another. For Joe Doe, the list includes the user's own address book, job history, document folder, as well as copy, scan and print function as shown in FIG. 4. Another user may, for example, see a list of applications which does not include the user's job history.

Each of the copy, scan, and secure print function is set to the personalize settings associated with the user (e.g. Joe Doe). For example, when Joe Doe selects the menu item Copy, his personalized settings for Copy are loaded into the MFP device. He can simply press Start button to start copying with his personalized settings for copy.

These embodiments give a user more control over his account and greatly increases work efficiency. Though a MFP is used as an example for illustration purpose, it should be noted that these embodiments may be similarly applied to other devices having a user interface and provide personalized settings for each of a plurality of users. In the following, two examples are used to illustrate certain benefits provided by these embodiments.

### EXAMPLE 1

A user of a MFP first sets their own personalized settings. The user logs into a web browser at, for example, a personal computer connected to the preference server. The user sets their personalized settings in the web browser which are in turn stored on the preference server in association with his user account.

The user then walks up to the MFP device and logs in with his account information. The MFP then retrieves the personalized settings stored on the preference server and associated with the user's account. The user now is presented with the personalized settings that he sets via the web browser.

For example, the user may be presented with the summary of his last activity. The user may browse through their device usage history. The user may see how many copies/prints he is allowed to make. The user may browse through documents that are stored in the remote document server, select one of the documents, and send it to his contacts in the contact list. The user may print the document using his preferred print settings. While the job is being processed, preferred news RSS feeds may be read at the front panel.

### EXAMPLE 2

This example illustrates using the personalized settings at two different MFP devices. One device is located in a local office while another at an overseas office. Both devices share the same preference server.

The user first logs into a web browser at, for example, a personal computer connected to the preference server. The user sets his or her personalized settings in the web browser which are in turn stored on the preference server in association with his user account.

The user then travels to an overseas office. He walks up to a MFP located in the overseas office and logs in. The MFP then retrieves the personalized settings stored on the preference server and associated with the user's account. The user now is presented with the personalized settings that he sets via the web browser, which is the same as he would get from the MFP device in his local office. The user browses through the documents that are stored in the remote document server, select the documents that need to be handed out during his overseas meetings, and print them out to disseminate and logs out.

After the meeting, the user obtains valuable handouts and documents from overseas partners, which are to be returned back to them. He walks up to the device in the overseas office and logs in. Again, his own personal settings are displayed. The user selects the preferred scan settings and his remote document server. He scans the documents to his remote document folder and also emails to himself and the colleagues in his local office. The user then logs out.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A system of providing personalized settings on a user interface of a multi-function peripheral (MFP), comprising:
a MFP with a user interface;
a preference unit configured to store a group of settings for each of a plurality of user accounts;
wherein the MFP is configured to a) log on a user to a user account, b) retrieve a group of settings associated with the user account from the preference unit, and c) customize the user interface of the MFP with the retrieved settings.

2. The system of claim 1, wherein the user interface is a front panel.

3. The system of claim 1, wherein the group of settings comprises at least one of the following: menu style, an address book, a contact list, a calendar, a remote document server, a list of work documents, virtual folders, user logs, a notepad, scan settings, facsimile settings, and print settings.

4. The system of claim 1, wherein the group of settings associated with each user account comprises access control on the user account.

5. The system of claim 1, wherein the preference unit is integrated within the MFP.

6. The system of claim 1, wherein the preference unit is connected to the MFP via a communication link.

7. The system of claim 1, wherein the preference unit comprises a web server.

8. The system of claim 1, wherein the preference unit allows a user to set or change groups of settings stored therein via a network connection.

9. The system of claim 1, wherein the preference unit is shared by more than one MFP.

10. The system of claim 1, further comprising a remote user interface connected to the preference unit via a network connection, the remote user interface allowing a user to set or change groups of settings stored at the preference unit with a web browser.

11. The system of claim 1, wherein the MFP is configured to receive authentication data from a user and link the user to a user account associated with the received authentication data.

12. The system of claim 11, further comprising an identity server configured to store a plurality of user accounts and the authentication data corresponding to each user account, and wherein the MFP links the user to a user account based on user account information stored on the identity server.

13. The system of claim 12, wherein the identity server is connected to the MFP via a communication link.

14. A method of providing personalized settings on a user interface of a multi-function peripheral (MFP), comprising:
retrieving a group of settings associated with a user account from a preference unit; and
customizing the user interface of the MFP with the retrieved settings.

15. The method of claim 14, wherein the user interface is a front panel.

16. The method of claim 14, further comprising logging on a user at the MFP to a user account.

17. The method of claim 16, wherein the logging on of a user comprises:
receiving authentication data from a user; and
linking the user to a user account associated with the authentication data.

18. The method of claim 14, further comprising:
updating a group of settings stored at the preference unit and associated with a user account, based on instructions received via a remote user interface connected to the preference unit.

19. The method of claim 14, further comprising:
updating a group of settings stored at the preference unit and associated with a user account, based on instructions received via a web browser connected to the preference unit.

20. The method of claim 14, further comprising:
at a remote user interface, logging on a remote user to a user account, the remote user interface being remotely connected to the preference unit; and
updating a group of setting stored at the preference unit and associated with the user account, based on instructions received from the remote user.

21. The method of claim 14, wherein the group of settings comprises at least one of the following: menu style, an address book, a contact list, a calendar, a remote document server, a list of work documents, virtual folders, user logs, a notepad, scan settings, facsimile settings, and print settings.

22. A system for providing personalized settings on a user interface of a multi-function peripheral (MFP), comprising:
means for logging on a user to a user account;
means for retrieving a group of settings associated with the user account from a preference unit; and
means for customizing the user interface of the MFP with the retrieved settings.

23. The system of claim 22, wherein the user interface is a front panel.

24. The system of claim 22, further comprising:
means for setting a group of settings stored at the preference unit associated with a user account via a remote user interface.

25. The system of claim 22, wherein the group of settings comprises at least one of the following: menu style, an address book, a contact list, a calendar, a remote document server, a list of work documents, virtual folders, user logs, a notepad, scan settings, facsimile settings, and print settings.
